(19) United States
(12) Patent Application Publication
(10) Pub. No.: US 2023/0273336 A1
(43) Pub. Date: Aug. 31, 2023

(54) DATA ACQUISITION METHOD OF THREE-DIMENSIONAL HIGH-DENSITY RESISTIVITY BASED ON ARBITRARY ELECTRODE DISTRIBUTION

(71) Applicant: Zhejiang University, Hangzhou (CN)

(72) Inventors: Bangbing WANG, Hangzhou (CN); Jiaxin WANG, Hangzhou (CN); Weihong TANG, Hangzhou (CN)

(21) Appl. No.: 18/313,133

(22) Filed: May 5, 2023

Related U.S. Application Data
(63) Continuation of application No. PCT/CN2021/082602, filed on Mar. 24, 2021.

(30) Foreign Application Priority Data
Nov. 6, 2020 (CN) 202011227505.3

(51) Int. Cl. G01V 3/38; G01V 3/02

(52) U.S. Cl. CPC G01V 3/38; G01V 3/02

(57) ABSTRACT

A data acquisition method for three-dimensional high-density resistivity based on arbitrary electrode distribution, comprising the following steps: evenly providing measurement points in a predetermined measurement area, and selecting endpoint positions and directions of electrode pairs according to surface conditions; sequentially moving a power supply to each of the measurement points according to the identification numbers, with the electrode pair at the current point as the power supply electrode pair, and the electrode pair within the effective measurement circle corresponding to the current point as the measurement electrode pair; continuing the process until all measurement points are powered, and a rolling measurement of the entire measurement area is complete.

### FIELD OF THE DISCLOSURE

The present invention relates to the field of electrical exploration technology, and specifically to a data acquisition method of three-dimensional high-density resistivity based on arbitrary electrode distribution.

### BACKGROUND OF THE DISCLOSURE

The high-density resistivity method (Electrical Resistivity Tomography, ERT or Electrical Resistivity Imaging, ERI) is an array exploration method developed from conventional resistivity exploration. In traditional high-density resistivity exploration, all electrodes are connected to the instrument through a cable. The instrument's internal program-controlled switch selects the power supply (A, B) and measurement (M, N) electrode combinations that meet the device setting requirements for automatic measurement according to the device type (e.g., Wenner, dipole-dipole, single pole-single pole, etc.). Then, the instrument calculates the apparent resistivity value ρₛ corresponding to the device parameters. The underground resistivity distribution in the measurement area is obtained through data processing, mainly inversion imaging. The advantage of high-density resistivity method is that all electrodes only need to be set up once, and the instrument selects the electrode combination for automatic measurement, saving manpower and improving data acquisition efficiency.

High-density electrical resistivity surveying in the wild mainly include two methods: 2D (two-dimensional) survey line exploration and 3D (three-dimensional) area exploration. The 3D exploration can help discover isolated underground anomalies or spatial distributions of geological bodies with certain orientations. It has been widely used in near-surface exploration fields such as urban underground space investigation. Currently, regular grid layout and S-shaped loop cable arrangement are two of the most widely used 3D high-density electrical resistivity surveying. However, this form of a long cable connecting all electrodes and the regular grid layout requirements limits its adaptability for surveying under complicated surface conditions such as rivers, roads, high-rise buildings, and hardened surfaces. This has prompted the development of some specially designed unconventional 3D observation systems, such as L-shaped, star-shaped, circular, and polygonal 3D observation systems. However, most of these specially designed observation systems are temporary developed to meet special surface exploration without considering the universal applicability and generality, making it difficult to form a complete, standardized, and systematic practical solution.

Current conventional 3D high-density electrical resistivity methods have the following shortcomings:

1. Only regular grid is acceptable for setting up electrodes, which severely limits the application of the high-density resistivity method in complex urban or environmental conditions, where it is difficult to find suitable and proper rectangular areas to set up electrodes.

2. A long cable is used to connect all electrodes, and measurements are made in serial order based on the position of electrodes in the cables. The bulky and long cable not only increases labor intensity, but also makes it difficult to lay the cable on site due to the presence of obstacles such as rivers, large buildings, and transportation arteries.

3. Current high-density electrical resistivity 3D surveying uses a regular grid to arrange measurement points/lines, and the movement of measurement points can only proceed in two orthogonal directions along the measurement lines. This is only a quasi-3D measurement, with electrodes randomly positioned to some extent. In addition, the current high-density electrical resistivity instruments only use four electrodes (for power/measurement) out of all the electrodes each time they take a measurement, resulting in low acquisition efficiency.

The high-density resistivity surveying based on arbitrary electrode distribution can flexibly select locations with good grounding conditions based on the site conditions. It is particularly suitable for exploration in complicated urban or environmental conditions. Ideally, the high-density resistivity surveying based on arbitrary electrode distribution can use one electrode pair for power supply during each measurement, with all other electrode pairs used for potential difference measurement, enabling simultaneous parallel measurements from multiple acquisition stations. However, when the distance between the power supply and sensing electrode pair is too far, the potential difference measured by the instrument will be lower than the noise level, making it difficult to obtain accurate apparent resistivity values. This method of data acquisition will lead to a large number of invalid operations and data, seriously affecting construction efficiency and data acquisition quality. As an innovative surveying, the high-density resistivity surveying based on arbitrary electrode distribution has excellent application potential and prospects for promotion. However, as a new technology, there are still some unresolved key technical issues in observation system design, data acquisition, and data processing. These issues include: 1. Observation system design: how to design an effective and concise data acquisition observation system to maximize the technical advantages of the arbitrary electrode distribution system. 2. Station rolling problem: when the number of instruments or acquisition stations is insufficient to cover the entire measurement area, how to find and move used acquisition stations to the measurement points, and achieve rolling measurement. 3. Layout of supplementary measurement points, when the imaging clarity (resolution) of the underground target of interest is found to be insufficient after data processing, how to efficiently add measurement points to quickly improve the detection target resolution.

As urbanization accelerates, the high-density electrical resistivity surveying based on arbitrary electrode distribution has become the most promising cutting-edge direction for exploration in complex urban and environmental conditions. However, the randomness and complexity of the arbitrary electrode distribution greatly increase the complexity of observation system layout, and the exploration depth and resolution are significantly uncertain. The design of observation systems and data acquisition methods, such as the order of measurement points and the rolling of devices, remains a technical bottleneck for the promotion and application of this method.

### SUMMARY OF THE DISCLOSURE

In view of the problems, the present invention provides an obversion method and a data acquisition method for three-dimensional high-density resistivity based on arbitrary electrode distribution.

The data acquisition method for three-dimensional high-density resistivity based on arbitrary electrode distribution includes the following steps.

(1) substantively providing measurement points in a predetermined measurement area evenly, and selecting endpoint positions and directions of electrode pairs according to surface conditions; one electrode pair is located at each measurement point, and each measurement point is given a unique identification number; collecting and recording coordinates of endpoint positions of all electrode pairs and the identification numbers; the length of the electrode pair is set as a=(½-⅓) H, where H is the survey depth.

(2) sequentially moving a power supply to each of the measurement points according to the identification numbers, with the electrode pair at the current point as the power supply electrode pair, and the electrode pair within the effective measurement circle corresponding to the current point as the measurement electrode pair; continuing the process until all measurement points are powered, and a rolling measurement of the entire measurement area is complete.

The effective measurement circle refers to the area within the circle with radius R drawn with the midpoint O of the two electrodes of the power supply electrode pair at the current measurement point as the center. The effective measurement radius R=(6-8) a.

Furthermore, when the electrode pair AB is used as the power supply electrode pair, and one of the measurement electrode pairs, MN within the effective measurement circle of the electrode pair AB will not be used again as a measuring electrode pair when MN is used as the power supply electrode pair, so as to avoid repeat measurements.

A data acquisition method of three-dimensional high-density resistivity based on arbitrary electrode distribution includes the following steps.

Step 1: Layout design of the observation system.

Selecting a high-definition satellite or aerial remote sensing image and marking the range of the measuring area in the remote sensing image; distributing the measuring points as evenly as possible within the measuring area; selecting the endpoint positions and directions of the electrode pairs based on surface conditions; one electrode pair is located at each measurement point, and each of the measurement points is assigned with a unique identifying number; collecting and recording record the coordinates of endpoint positions of all electrode pairs and identification numbers; the length of the electrode pair is a=(⅓-½) H, where H is the exploration depth.

Step 2: On-site verification.

Conduct on-site verification of the measuring points and electrode pair endpoint positions designed in Step 1. Check the surface conditions of each measuring point. If the on-site conditions corresponding to the measuring points designed in the remote sensing image do not meet the measuring point layout conditions, adjust the measuring point position or cancel the measuring point. Collect the coordinates of all electrode pair endpoint positions and measuring point numbers that have been verified in Step 2 using surveying instruments. Then insert obvious markers with the electrode pair numbers at the position of the electrode pairs corresponding to the on-site measuring points;

Step 3: Update the observation system based on the data collected in Step 2. According to the identifying number of the measuring points, take the electrode pair at the current measuring point in the observation system as the power-supplying electrode pair and generate a measurement electrode pair sequence within the effective measurement circle of each power-supplying electrode pair;

The effective measurement circle is the area within the circle with midpoint o of the two electrodes of the current power-supplying electrode pair as the center and R as the effective measurement radius, where R=(6˜8) a;

Step 4: Perform parallel measurements by sequentially designating the power-supplying electrode pairs and their corresponding measurement electrode pair sequences in the observation system, obtaining the apparent resistivity of each power-supplying-measurement electrode pair until all measuring points have been powered;

Step 5: Perform inversion imaging of the underground detection target based on all apparent resistivities obtained during the measurement process.

Furthermore, in Step 4, when obtaining the measurement electrode pair sequence for each power-supplying electrode pair based on the effective measurement circle, if there exists an electrode pair that has previously been paired with the power-supplying electrode pair, it will be removed from the measurement electrode pair sequence.

Moreover, after performing inversion imaging in Step 5, if the resolution of a detection target at a certain location does not meet the design requirements, add electrode pairs around the detection target, and use only the newly added electrode pairs as the power-supplying electrode pairs, while using all other electrode pairs within their effective measurement circles as measurement electrode pairs. Conduct supplementary measurements using the methods of Step 3 to Step 5.

### BRIEF DESCRIPTION OF DRAWINGS

FIG. 1 is a schematic diagram of an arbitrary distributed dipole device.

FIG. 2 is a layout diagram of the on-site observation system.

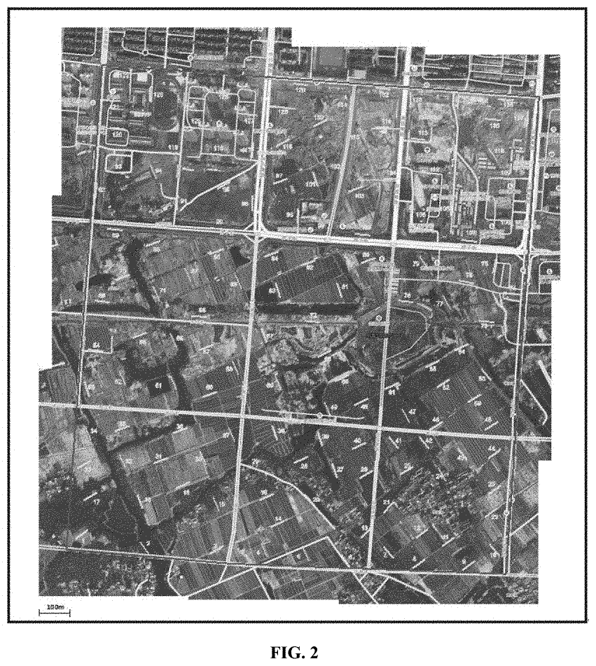

FIG. 3 is a schematic diagram of the design of the observation system and the rolling mode of measuring points according to the present invention.

FIG. 4 is a flow diagram of the data acquisition method according to the present invention.

FIG. 5 is a arrangement diagram of the supplementary survey and optimized measuring points according to the present invention.

### DETAILED DESCRIPTION OF THE DISCLOSURE

The present invention will be described in detail below according to the accompanying drawings and preferred embodiments, and the purpose and effect of the present invention will become clearer. It should be understood that the specific embodiments described here are only used to explain the present invention, and are not intended to limit the present invention.

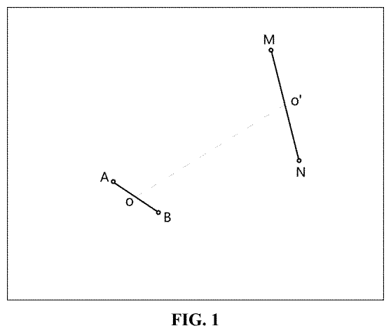

The arbitrary dipole device (FIG. 1) is the most common dipole layout method, and it is more suitable for the arbitrary arrangement of devices under complex surface conditions in the field. The length (dipole moment “a”) of the power supply electrode pair AB and the measuring electrode pair MN of the arbitrary dipole, the distance (electrode distance “L”) between the midpoint o of AB and the midpoint o′ of MN, and the density of measuring points have an important influence on the detection rate and detection depth, and become the key to the design of the observation system.

I. Parametric Design

Dipole moment: The greatest advantage of an arbitrary distribution system is its flexibility in placing the positions and orientations of electrode pairs based on the surface conditions at the site. In designing the observation system, the length (dipole moment “a”) of the electrode pairs AB and MN can be unequal, but it is recommended to use approximately equal lengths during field deployment to facilitate system design and construction. The length of the electrode pairs is related to both the survey depth and resolution. Shorter electrode pairs lead to higher resolution, but shallower survey depth. It is recommended to use a dipole moment length of a=(½-⅓)H (where H is the design survey depth) when considering the design of electrode pairs. For example, if the survey depth H is 150 m, the design length of the electrode pairs can be considered as a=50 m.

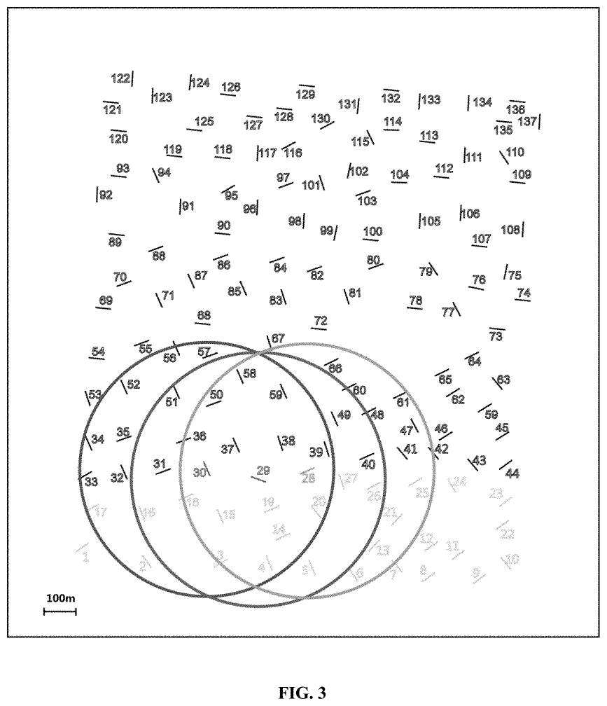

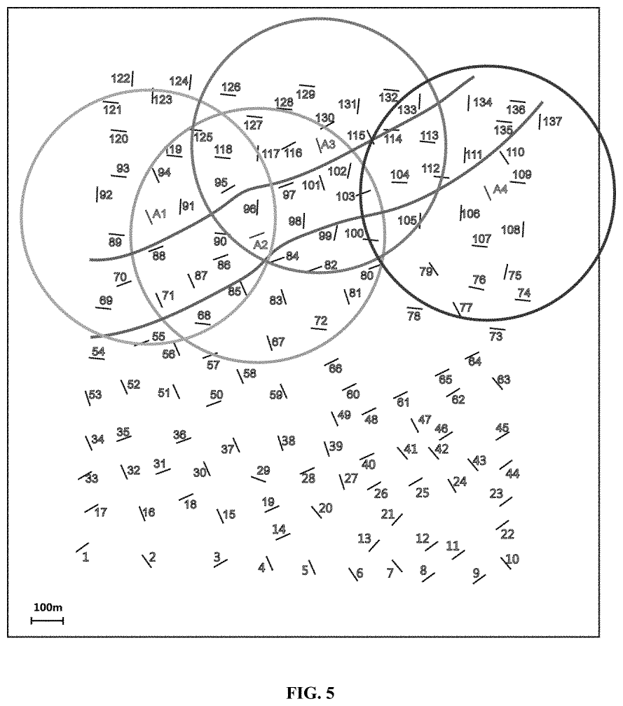

Effective measurement radius: Due to limitations in the precision of the instrument, when the distance L between the electrodes of the dipole device (as shown in FIG. 1, distance oo′) is beyond 6-8 times the range of the dipole moment a, the potential difference measured by MN is lower than the background noise level, and the instrument will have difficulty in accurately reading the potential difference and obtaining the true apparent resistivity value. In other words, when the electrode distance is greater than 8 times the dipole moment, the reliability of the measured apparent resistivity value is lower. Therefore, for each center o of the power supply electrode pair, there is an effective measurement radius R, which is equal to (6-8)*a. The potential measurement points of the MN electrodes designed within the radius of the circle with R as the radius can ensure the reliability of the measurement results to the greatest extent. If the dipole moment “a” is 50 m, then the effective measurement radius R is 400 m (the measurement electrode pairs within the circles in FIGS. 3 and 5 are reliable measurement points corresponding to the power supply point).

Based on this, the present invention proposes the concept of an “effective measurement circle,” which refers to a circular area formed by drawing a circle with a radius of the effective measurement radius R (R=n*a, where n is usually 6-8 and can be adjusted appropriately based on field test results) around the center point o of each power supply electrode pair AB. The MN potential measurement points designed within this circular area can ensure the reliability of the measurement results. The effective measurement circle is the core concept of the present invention, and the electrode random distribution-based 3D high-density electrical resistivity tomography (ERT) observation method and data acquisition method of the present invention are both based on this effective measurement circle.

The density of measurement points: The arbitrary distribution system does not have any particular requirements for the placement and orientation of the electrode pairs, but creating conditions for uniform placement in a measurement area is beneficial for the uniform detection of underground targets. After determining the value of the dipole moment a, it is advisable to use a spacing between measurement points of 1 to 4 times the value of the dipole moment a to ensure that measurement points are distributed at near, medium, and far distances.

Below, we will introduce the observation method and data acquisition method for the three-dimensional high-density electrical method based on the effective measurement circle described above and implemented through random distribution of electrodes.

The method for electrode-randomized distributed three-dimensional high-density electrical resistivity imaging of the present invention includes the following steps:

(1) Uniformly distribute measurement points within the predetermined measurement area and flexibly select the positions and directions of the electrode pair endpoints based on surface conditions. Set up one electrode pair for each measurement point and assign a unique identification number to each measurement point. Collect and record all electrode pair endpoint coordinates and measurement point identification numbers. The length of the electrode pair, a, is equal to ½ to ⅓ of the exploration depth, H.

(2) Sequentially move the power station to each measurement point according to its identification number. Use the electrode pair at the current measurement point as the power supply electrode pair and use the electrode pair within the effective measurement circle corresponding to the current measurement point as the measurement electrode pair for measurement. Repeat this process for all measurement points to complete the entire rolling measurement of the measurement area.

The effective measurement circle is the area inside a circle drawn with the midpoint o of the power supply electrode pair at the current measurement point as the center, and with a radius of R. The effective measurement radius R is equal to 6 to 8 times the length of the electrode pair, a.

The method for electrode-randomized distributed three-dimensional high-density electrical resistivity imaging of the present invention includes the following steps:

Step 1: Design of the observation system

Choose the latest high-resolution satellite or aerial remote sensing image and mark out the scope of the measurement area. Then, based on the designed dipole moment and measurement point density, distribute measurement stations and electrode pair endpoints as uniformly as possible within the measurement area. The direction of the electrode pairs depends on the surface conditions (ensuring sufficient dipole moment length) and good grounding conditions (avoiding obstacles such as buildings, hard surfaces, and rivers). When there are villages, large ground buildings, or other hard surfaces, the measurement point density can be increased in the surrounding area. Then, draw the electrode pairs on the remote sensing image proportionally and assign a unique identification number to each measurement station in order.

Step 2: On-site verification

The delayed update of remote sensing images often results in discrepancies between the surface conditions in the image and the actual site conditions (especially in newly developed urban areas), requiring on-site inspections. Check the surface conditions of each measurement point. If the site conditions do not meet the exploration construction conditions at the designed measurement point, the measurement point needs to be adjusted or canceled according to the site conditions. Then, record the modification results in detail and update the observation system promptly. For the verified on-site measurement points, use surveying instruments such as GPS to collect the electrode pair position coordinates and identification numbers for subsequent data collection optimization design. Then, insert conspicuous markers with electrode pair identification numbers at the position of each electrode pair on-site to facilitate the search for measurement station points during subsequent data collection.

Step 3: Data collection and optimization.

(1) Firstly, update the observation system based on the data collected in step two.

(2) Calculate and generate the set of effective measurement stations:

For each supply electrode pair AB, draw a circle with radius R around the midpoint o of AB. The electrode pairs within the circle are the set of measurement electrode pairs that meet the requirements. The specific programming calculation process is as follows: calculate the coordinates (x₁, y₁) of the midpoint o based on the coordinates of points A and B, and then calculate the coordinates (x₂, y₂) of the midpoints o′ of all other electrode pairs. Then calculate the distance L between o and o′ using Formula (1):

L=\sqrt{(x₂−x₁)²+(y₂−y₁)²} (1)

Electrode pairs with L<R are within the effective measurement circle and are the measurement station points that meet the requirements. These points together form the set of effective measurement stations. It should be noted that the set of effective measurement stations is specific to a selected supply station point. If the supply station point changes, the corresponding set of measurement station points also changes. There is a one-to-many relationship between the supply station point and the set of measurement station points.

Taking the station point with pile number 28 in FIG. 3 as an example, when the supply is provided at station point 28, the corresponding set of effective measurement stations is the set of measurement electrode pairs that meet the conditions and are within the circle centered at the midpoint of electrode pair 28 with a radius of R=400 m (assuming a=50 m, n=8). The electrode pairs with pile numbers 3 to 7, 13 to 15, 18, 25 to 30, 36 to 41, 47 to 50, 58 to 61, and 66 within the circle are all the measurement electrode pairs that meet the requirements and correspond to the supply electrode pair 28.

(3) Optimization of the effective measurement station set:

The principle of interchangeability is satisfied between the power supply points AB and the measurement points MN in electrical exploration. In the ideal condition of interchanging the positions of the power supply AB and the measurement points MN, the measured apparent resistivity values are equal. By utilizing this principle, the number of repetitive measurement points can be optimized and reduced, thereby improving the efficiency of data collection. In FIG. 3, if the distance between electrode pair 3 and 28 is less than or equal to the effective measurement radius R, and if electrode pair 3 is used as the power supply AB and electrode pair 28 as the measurement point MN for the first measurement, then according to the principle of interchangeability, the results of the measurement where electrode pair 28 is the power supply AB and electrode pair 3 is the measurement point MN will be equal to the previously mentioned measurement.

Therefore, the repetitive measurement operation can be canceled. The constraint of the effective measurement radius greatly reduces the workload of data collection, and the principle of interchangeability further optimizes the collection process, reducing the number of collection points within the effective collection circle (approximately halving the gray stake numbers within the circular area in FIG. 3). This not only improves the efficiency of data collection but also enables the collection station at electrode 3 to become idle as early as possible, moving to a new site to wait for measurement (rolling measurement station).

(4) The rolling measurement of the data acquisition block: When using a distributed acquisition station or a multi-channel instrument system for three-dimensional measurement, the measurement system cannot achieve complete coverage of the entire measurement area in one go due to the limitation of the number of acquisition stations or channels of the instrument system, so it needs to be divided into multiple sub-blocks for block measurement. The docking and splicing between the sub-blocks is always a technical problem in the design and data acquisition of the three-dimensional high-density electrical observation system, which requires careful design and construction to ensure that the data can be fully docked and cover the entire measurement area.

This invention makes the following agreements and operations during the rolling process of the acquisition station: Each acquisition station that is connected to the instrument system will be registered and assigned a unique number based on the position of the measurement point. The system will automatically calculate the measurement electrode pair sequence corresponding to each supply electrode pair according to the definition of the effective measurement circle and the optimized results of the data. When the supply station moves to the next number, the system will automatically calculate and check whether all the measurement stations that meet the conditions and their measurement electrode pairs have been successfully connected to the system. If yes, a new supply and measurement process will begin. If not, the system will issue an alarm to remind that the required measurement acquisition station has not been connected to the system and display its location and number. The on-site operator can move the previously used acquisition station to the position of the subsequent measurement station according to the prompt, connect it to the system, and register the number of the new location of the acquisition station, to achieve rolling measurement when the number of acquisition stations is insufficient, until the complete coverage of the entire measurement area is completed.

The use of a randomized distributed system design and the concept of effective measurement circles greatly simplifies the collection rolling process. There is no need to design and calculate the connection and integration of the next measurement segment with the previous one. Instead, the collection of potential differences of all measurement stations within the effective measurement circle corresponding to each power supply station can be completed in sequence according to their supply station numbers, thus completing one measurement operation. Then, the next power supply station is moved to in sequence and the potential differences of all measurement stations corresponding to this station are collected to achieve a rolling measurement. During the rolling process, operations to move and supplement the completed collection stations to the waiting measurement points are performed based on system prompts, until the last point is completed and the collection process ends, thereby completing the rolling measurement of the entire measurement area.

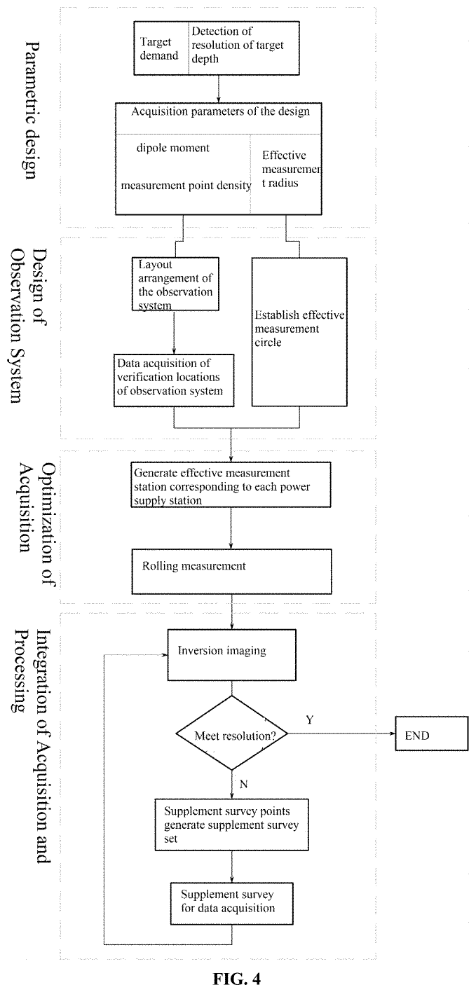

FIG. 4 illustrates the complete process of design and data acquisition optimization for the random distributed high-density electrical observation system. Based on the exploration depth and resolution requirements of the detection target, the dipole moment “a” and effective measurement radius “R” are calculated. Furthermore, all electrode pairs are designed, collected, and organized together with their location information. Each power supply electrode pair is associated with a measurement electrode pair set, which is calculated and optimized. During the acquisition process, the power supply electrode pairs are incremented in sequence starting from the smallest number, and the corresponding measurement electrode pair sets are measured in the calculated order or in parallel. The next power supply electrode pair is selected in increasing order, and the above process is repeated until all measurement points are powered, thus completing the entire rolling measurement of the measurement area.

Taking FIG. 3 as an example, the process of optimizing the data acquisition and implementing the rolling measurement of the random distributed high-density electrical method observation system is explained. Assuming station 28 as the power supply electrode pair, the previous electrode pairs from 1 to 27 either fall outside the effective measurement radius and do not participate in the measurement process of this point (such as stations 1, 2, 6, etc.), or have already been measured and obtained the apparent resistivity values between the ABMN points based on the theory of power supply/measurement electrode exchange (such as stations 3, 4, 5). Therefore, after optimization, the stations with a smaller number than station 28 will not participate in the subsequent measurement process, and the electrodes and acquisition stations of these stations can be moved and supplemented to other blank stations in the future. The stations in the upper half of the circle, such as stations 29, 30, 36-41, 47-50, 58-61, 68, etc., are the stations that need to be collected. Similarly, when measuring the next station 29, except for the stations with numbers 1-28, station 28 has also been measured, so only stations 30-31, 36-40, 48-50, 58-59, and other numbered stations need to be measured. The entire rolling measurement starts from the power supply at station 1 and continues until the measurement of station 136 is completed (station 137 does not have a corresponding measurement station and is not included in the consideration), completing the entire measurement.

(5) Based on the measured apparent resistivity, the underground exploration target is inverted and imaged.

Due to limitations in surface conditions or lack of information about the underground target, there may be various deficiencies and limitations in the observation system parameters during the initial and detailed exploration processes. This may result in unsatisfactory imaging resolution of the underground target, which could affect the interpretation accuracy and precision of the exploration results. Thus, it is necessary to improve the imaging effect by supplementing the exploration points through a follow-up exploration process.

(6) Supplemental Survey

Strategic Layout of Key Survey Points: Theoretical analysis and model calculations indicate that placing survey points in the area adjacent to the exploration target has a higher weighting factor for improving target imaging resolution. Therefore, for the discovered “blurry” target, it is a better choice to supplement an appropriate number of survey points in the vicinity of the target area. This invention fully utilizes the results of previous measurements to optimize the supplemental data acquisition plan: selecting appropriate locations near the target anomaly to supplement survey points (as power supply survey stations only), generating a new set of measurement stations centered around the survey station (original observation system survey station position and number), and supplying/measuring to obtain a new set of visual resistivity data. Then, move on to the next new supplemental survey point and repeat the process.

FIG. 5 illustrates the related measurement process of the supplementing measurement points. Assuming that there is a low-resistance broken zone (northeast-southwest direction) in the upper part of the measurement area, it is necessary to supplement four measurement points A1 to A4 to improve the imaging resolution of the broken zone. For the A1 point, the supplementing process is as follows: take A1 as the power supply measurement station, draw a circle with R=400 m, and all the measurement stations originally placed within the circle are the points to be measured, including stations 55, 68-71, 85-96, 117-121, and 123. Since the A1 measurement station is a newly added power supply station and has not undergone any exchange measurements with the above-mentioned measurement stations, there is no need to optimize and discard any measurement stations during the supplementing measurement process. All the other related measurement stations have already undergone power supply/measurement operations in previous explorations, so there is no need to repeat the measurements. The supplementing measurement points in the present invention only serve as power supply measurement stations, and they are combined with the measurement stations in the original observation system to make full use of the existing exploration results data, and the process of supplementing measurements is extremely simple and efficient.

(7) Integration of Acquisition and Processing:

The placement of additional measurement points during the supplementary exploration still carries some degree of uncertainty and guesswork. If we wait until the data is processed in the office to determine the effectiveness of the added points and decide whether to rearrange the stations, it will result in enormous waste of time and manpower due to repeated station placements and removals. Therefore, after the field data acquisition is completed, we should immediately utilize the computing power of the on-site computer (which has installed inversion processing software) to conduct data processing and imaging. Based on the imaging results, we can select the location for the placement of new power supply measurement stations and simultaneously supplement other measurement acquisition stations within the effective measurement circle to complete one supplementary station measurement. We repeat this process to complete the supplementary station measurement for other points. Then, we merge the supplementary station measurement data with the original measurement data, conduct inversion processing, and analyze the improvement effect of the resolution. If the expected effect is achieved, the supplementary exploration will be completed. If not, we continue to repeat the supplementary point placement and exploration->inversion until the best resolution is achieved.

This type of on-site integrated collection and processing greatly reduces the work cycle and significantly reduces labor intensity (reducing the workload of station layout and removal), greatly improving work efficiency.

The examples provided above are only preferred embodiments of the invention and should not be construed as limiting the scope of the invention. While detailed descriptions have been provided with reference to the aforementioned embodiments, those skilled in the art can still modify the technical solutions described in these embodiments or replace some technical features with equivalent ones. Any modifications, equivalent replacements, or similar changes made within the spirit and scope of the invention should be encompassed within the protection scope of the invention.

What is claimed is:

1. A data acquisition method for three-dimensional high-density resistivity based on arbitrary electrode distribution, comprising the following steps:
(1) evenly providing measurement points in a predetermined measurement area, and selecting endpoint positions and directions of electrode pairs according to surface conditions; one electrode pair is located at each measurement point, and each measurement point is given a unique identification number; collecting and recording coordinates of endpoint positions of all electrode pairs and the identification numbers; the length of the electrode pair is set as a=(½-⅓)H, where H is the survey depth;
(2) sequentially moving a power supply to each of the measurement points according to the identification numbers, with the electrode pair at the current point as the power supply electrode pair, and the electrode pair within the effective measurement circle corresponding to the current point as the measurement electrode pair; continuing the process until all measurement points are powered, and a rolling measurement of the entire measurement area is complete;
wherein the effective measurement circle refers to the area within the circle with radius R drawn with the midpoint o of the two electrodes of the power supply electrode pair at the current measurement point as the center. The effective measurement radius R=(6-8)a.

2. The method according to claim 1, wherein when the electrode pair AB is used as the power supply electrode pair, and one of the measurement electrode pairs, MN within the effective measurement circle of the electrode pair AB will not be used again as a measuring electrode pair when MN is used as the power supply electrode pair, so as to avoid repeat measurements.

3. A data acquisition method for three-dimensional high-density resistivity based on arbitrary electrode distribution, comprising the following steps:
Step 1: layout design of the observation system;
selecting a high-definition satellite or aerial remote sensing image and marking the range of the measuring area in the remote sensing image; distributing the measuring points as evenly as possible within the measuring area; selecting the endpoint positions and directions of the electrode pairs based on surface conditions; one electrode pair is located at each measurement point, and each of the measurement points is assigned with a unique identifying number; collecting and recording record the coordinates of endpoint positions of all electrode pairs and identification numbers; the length of the electrode pair is a=(⅓-½) H, where H is the exploration depth;
Step 2: on-site verification;
conducting on-site verification of the measuring points and electrode pair endpoint positions designed in Step 1; checking the surface conditions of each measuring point. If the on-site conditions corresponding to the measuring points designed in the remote sensing image do not meet the measuring point layout conditions, adjust the measuring point position or cancel the measuring point; collecting the coordinates of all electrode pair endpoint positions and measuring point numbers that have been verified in Step 2 using surveying instruments; then inserting obvious markers with the electrode pair numbers at the position of the electrode pairs corresponding to the on-site measuring points;
Step 3: updating the observation system based on the data collected in Step 2; according to the identifying number of the measuring points, taking the electrode pair at the current measuring point in the observation system as the power-supplying electrode pair and generate a measurement electrode pair sequence within the effective measurement circle of each power-supplying electrode pair; the effective measurement circle is the area within the circle with midpoint o of the two electrodes of the current power-supplying electrode pair as the center and R as the effective measurement radius, where R=(6-8) a;
Step 4: performing parallel measurements by sequentially designating the power-supplying electrode pairs and their corresponding measurement electrode pair sequences in the observation system, obtaining the apparent resistivity of each power-supplying-measurement electrode pair until all measuring points have been powered;
Step 5: performing inversion imaging of the underground detection target based on all apparent resistivities obtained during the measurement process.

4. The method according to claim 1, wherein in Step 4, when obtaining the measurement electrode pair sequence for each power-supplying electrode pair based on the effective measurement circle, if there exists an electrode pair that has previously been paired with the power-supplying electrode pair, it will be removed from the measurement electrode pair sequence.

5. The method according to claim 3, wherein after performing inversion imaging in Step 5, if the resolution of a detection target at a certain location does not meet the design requirements, add electrode pairs around the detection target, and use only the newly added electrode pairs as the power-supplying electrode pairs, while using all other electrode pairs within their effective measurement circles as measurement electrode pairs, and conducting supplementary measurements using the methods of Step 3 to Step 5.
